(19) United States
(12) Patent Application Publication
(10) Pub. No.: US 2024/0270492 A1
(43) Pub. Date: Aug. 15, 2024

(54) SERVICE VEHICLE UNIT

(71) Applicant: Autostore Technology AS, Nedre Vats (NO)

(72) Inventor: Trond Austrheim, Etne (NO)

(73) Assignee: Autostore Technology AS, Nedre Vats (NO)

(21) Appl. No.: 18/566,875

(22) PCT Filed: Jun. 2, 2022
(86) PCT No.: PCT/EP2022/065038

§ 371 Date: Dec. 4, 2023

(30) Foreign Application Priority Data
Jun. 4, 2021 (NO) 20210714

(51) Int. Cl. B65G 1/04; B61F 5/30; B66F 9/075

(52) U.S. Cl. CPC B65G 1/0492; B66F 9/07586; B61F 5/305

(57) ABSTRACT

A system for connecting two or more wheel modules operating on an automated storage and retrieval system, wherein the system comprises: a rail system comprising a first set of parallel rails arranged to guide movement of a container handling vehicle in a first direction (X) across the top of a frame structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, and a Service Vehicle Unit (SVU) configured to operate on the rail system and is wherein that the SVU is mounted on two or more wheel modules that are coupled together using a connecting device, wherein the connecting device and the frame of the two or more wheel modules are attached to each other at attachment points and that there are placed a shock absorbing component at the attachment point between the connecting device and the frame of the two or more wheel modules.

### FIELD OF THE INVENTION

The present invention relates to an SVU for operating in an automated storage and retrieval grid for storage and retrieval of containers, in particular to an SVU for operating in an automated storage and retrieval grid comprised of two or more wheel modules.

### BACKGROUND AND PRIOR ART

FIG. 1 discloses a typical prior art automated storage and retrieval system 1 with a framework structure 100 and FIGS. 2, 3 and 4 disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminium profiles.

The framework structure 100 of the automated storage and retrieval system 1 comprises a rail system 108 arranged across the top of framework structure 100, on which rail system 108 a plurality of container handling vehicles 201, 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201, 301, 401 in a first direction X across the top of the frame structure 100, and a second set of parallel rails 111 arranged perpendicular to the first set of rails 110 to guide movement of the container handling vehicles 201, 301, 401 in a second direction Y which is perpendicular to the first direction X. Containers 106 stored in the columns 105 are accessed by the container handling vehicles 201, 301, 401 through access openings 112 in the rail system 108. The container handling vehicles 201, 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 301b, 201c, 301c, 401b, 401c which enable the lateral movement of the container handling vehicles 201, 301, 401 in the X direction and in the Y direction, respectively. In FIGS. 2, 3 and 4 two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 301b, 201c, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z which is orthogonal the first direction X and the second direction Y. Parts of the gripping device of the container handling vehicles 301, 401 are shown in FIGS. 3 and 4 indicated with reference number 304, 404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119, 120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different levels, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 which typically is computerized and which typically comprises a database for keeping track of the storage containers 106.

The tracks on top of the storage and retrieval system is not always completely level. The tracks can become uneven after some time due to the container handling vehicles constantly driving back and forth on them. When a vehicle that is comprised of several wheel modules travels along tracks that is not even the vehicle can become unstable and there is a risk that the vehicle will derail.

It is therefore a need for a solution that ensures that vehicles that is comprised of two or more wheel modules can travel safely along the top of the grid without the risk of incidents.

### SUMMARY OF THE INVENTION

The present invention is set forth and characterized in the independent claims, while the dependent claims describe other characteristics of the invention.

In one aspect, the invention is related an SVU for operating in an automated storage and retrieval grid, the automated storage retrieval grid comprising a rail system comprising a first set of parallel rails arranged to guide movement of a container handling vehicle in a first direction (X) across the top of a frame structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells wherein it comprises two wheel modules that are coupled together using a connecting device wherein the connecting device is attached to the respective frame of the two or more wheel modules at attachment points, and in that there is placed an elastic component at each attachment point between the connecting device and the frame of the two or more wheel modules.

The shock absorbing component can be comprised of an upper plate and a lower plate, and an elastic material sandwiched between the upper plate and the lower plate.

The upper plate and the lower plate and the elastic material each can have a central hole for receiving a screw or a bolt, further the elastic material can be a rubber material, the shock absorbing component can be a spring, optionally a helical spring, the connecting device can be a plexiglass cover, the connecting device can be a platform on which the SVU body is mounted.

The connecting device can comprise at least one metal bar.

One wheel module of the two coupled wheel modules can be configured to act as a master and the other wheel module can be configured to act as a slave module.

A torsion bar can be connected at one end to a track shift mechanism of the master wheel module and at the opposite end connected to a track shift mechanism in the slave wheel module and is used for ensuring simultaneous track shift of the master and the slave wheel module.

The connecting device can partially cover the top of the two or more wheel modules.

The connecting device can fully cover the top of the two or more wheel modules.

Hence, the problems with instability of a vehicle comprised of two or more wheel modules that are connected together and traveling over tracks that are not completely even is solved by using a flexible connection when connecting the one or more wheel modules together.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view of a container handling vehicle with a central cavity solution. This image presents a view upwards with the lifting platform partially lowered. It is also possible here to see that the container handling vehicle with the central cavity solution can take up more space than one cell.

FIG. 5 is a perspective view of a Service Vehicle Unit (SVU) where we have a top unit, comprising the machinery for lifting and aiding a broken-down container handling vehicle, mounted on a platform which is mounted to two wheel modules.

FIG. 6 is a perspective top view of the two wheel modules onto which the platform with the machinery for lifting and aiding a broken down container handling vehicle is mounted.

FIG. 7 is a perspective side view of the two wheel modules wherein they are connected to each other by both being connected to the same platform.

FIG. 8 is a perspective view of a preferred embodiment of a flexible attachment point used for attaching the platform to the wheel modules.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

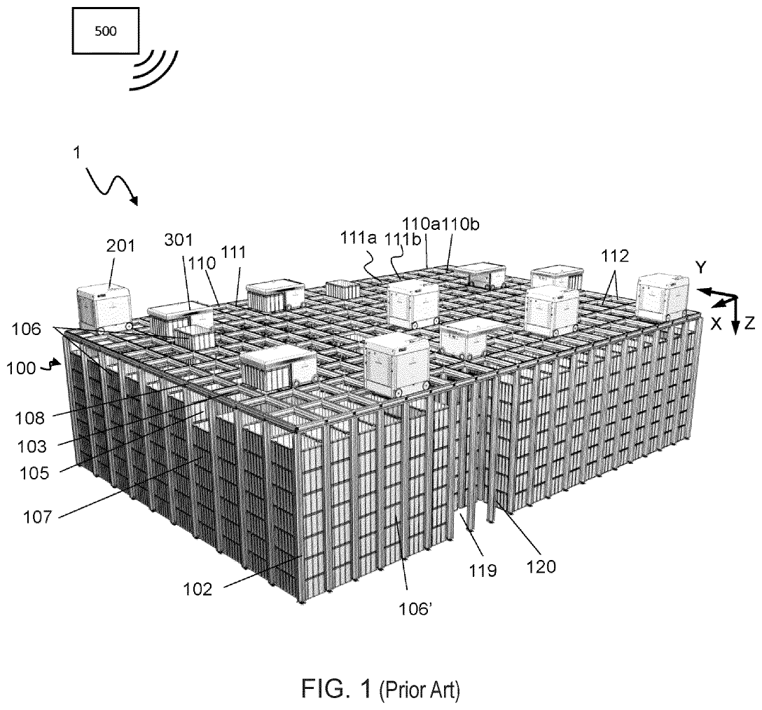

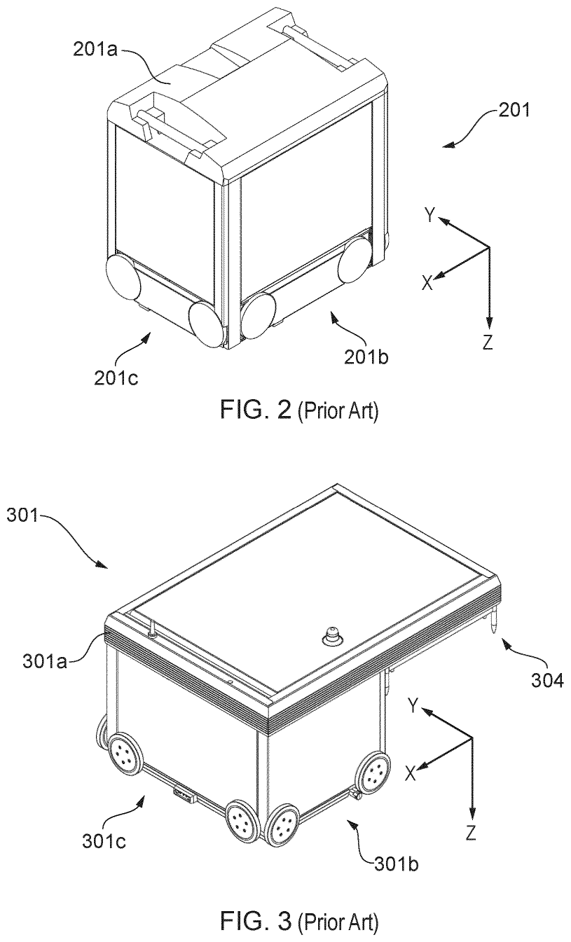

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

One embodiment of the automated storage and retrieval system according to the invention will now be discussed in more detail with reference to FIGS. 5-9

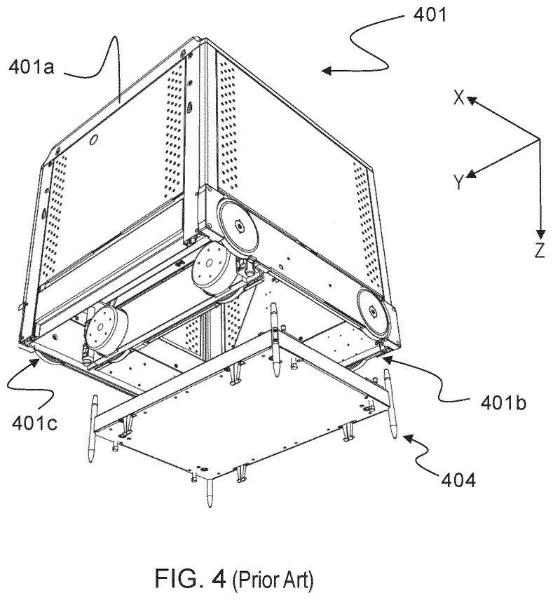

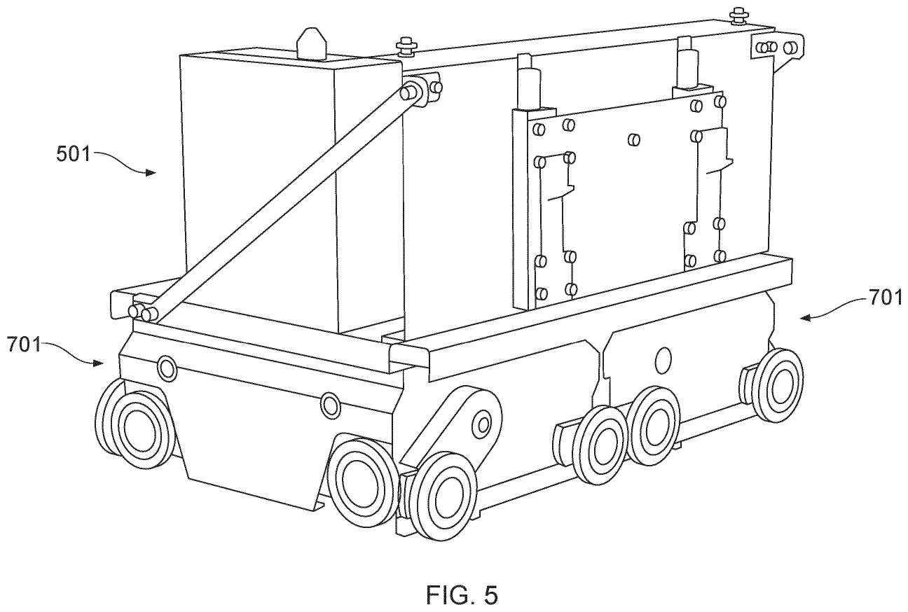

FIG. 4 is a perspective view of a container handling vehicle with a central cavity solution. This image presents a view upwards with the lifting platform partially lowered. It is also possible here to see that the container handling vehicle with the central cavity solution can have a footprint of more than one cell.

FIG. 5 is a perspective view of a Service Vehicle Unit (SVU) where we have a top unit, comprising the machinery for lifting and aiding a broken-down container handling vehicle, mounted on a platform 801 which is mounted to two wheel modules 701.

Each wheel module 701 has a footprint of one cell. In this embodiment the SVU has two wheel modules 701 mounted next to each other. On top of the wheel modules 701 it is mounted a top unit. The top unit is used to help container handling vehicles that are broken down on the grid to a service station.

In an embodiment of the present invention where there are two or more wheel modules 701, one of the wheel modules 701 are a master and the rest of them are slaves. The master is the wheel module 701 that communicates with the central computer system and the slaves do what the master instructs.

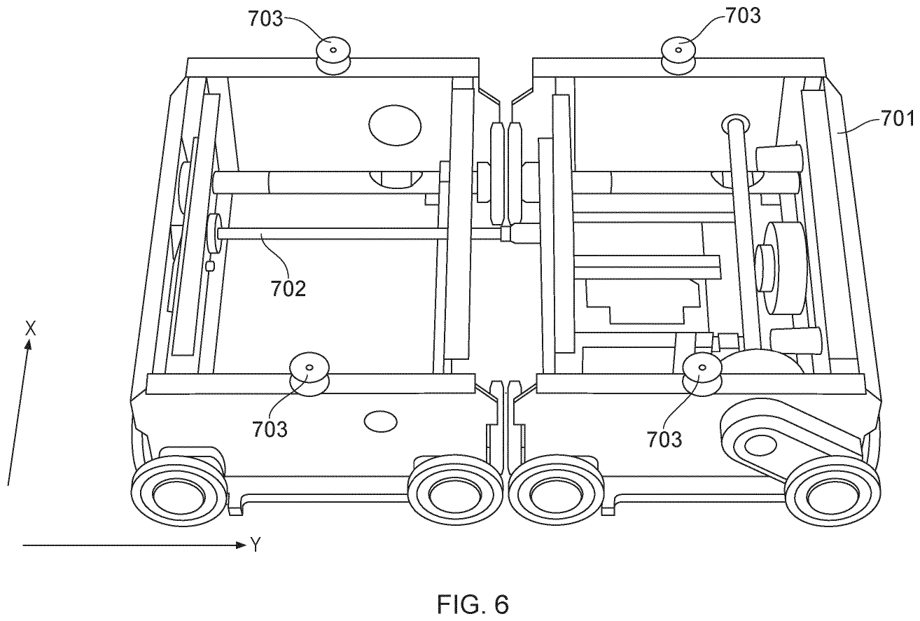

FIG. 6 is a perspective top view of two wheel modules 701 onto which the platform 801 with the top unit for lifting and aiding a broken down container handling vehicle is mounted.

In this drawing we can see two wheel modules 701 connected. Each wheel module 701 has two wheels on either side for being able to manoeuvre in either the X-direction or in the Y-direction. The wheels for manoeuvring in the X direction can be lifted and lowered depending on which direction the wheel module 701 is being told to manoeuvre.

The wheel module 701 on the right in the image is considered to be the master wheel module 701. The master wheel module 701 has an electric motor for powering the wheels. Further, the master wheel module 701 can have a power supply for the motor. This power supply can be in the form of a battery. Alternatively, it can be two power supplies in the form of a battery and a capacitor.

The master wheel module 701 can also be supplied with a transceiver making it possible to receive and transmit information and instructions from the central computer system. Alternatively, the communication can be received from a manual control of the SVU or a remote control of the SVU.

The master wheel module 701 and the slave wheel module 701 are connected via a torsion bar 702. This torsion bar 702 going from the master wheel base to the slave wheel base is for controlling the track shift mechanism in the slave module. In this embodiment the track shift mechanism is responsible for raising and lowering the wheel for manoeuvring in the X-direction.

If the wheel module 701 is told the manoeuvre in the X-direction the wheel in the X-direction is lowered to such an extent that the wheels for traveling in the Y-direction is lifted above the tracks of the grid. If the wheel module 701 is told to travel in the Y-direction the wheel for traveling in the X-direction is raised until they are clear of the tracks on the grid and the wheels for traveling in the Y-direction is placed in the tracks on the grid.

The track shift, or the raising and lowering of the wheels in the X-direction, is controlled by the computer on board the SVU that has received instruction where to manoeuvre.

The wheels for traveling in the X-direction is connected to a plate, the plate can be lifted up and down, lifting up and down the wheels. The lifting and the lowering of the wheels in the master wheel module 701 can be done by an electric motor or a pneumatic solution or a hydraulic solution.

In order for the SVU to operate properly the track shift must be performed simultaneously on both the master- and the slave wheel module 701. So, a torsion bar 702 702 is fitted to the track shift solution on the master wheel module 701 in order to transfer the power to raise and lower the wheels from the master wheel module 701 to the slave wheel module 701. The torsion bar 702 is fitted at one end to the raising and lowering unit on the master wheel module 701 and in the other end to the raising and lowering solution on the slave wheel module 701. So, when the master wheel module 701 is being told to either raise or lower the wheels for traveling in the X-direction both the wheels on the master wheel module 701 and the wheels on the slave wheel module 701 is raised and lowered at the same time due to the torsion bar 702 connects the two raising and lowering solutions together.

When two wheel modules 701 are connected together, it is necessary for them to have the ability to have a flex in the connection in order for the SVU to be able to take up any unevenness in the tracks on the grid. The torsion bar 702 has a flexibility since it is made out of metal, and preferably steel. The flexibility makes it possible for the torsion bar 702 to flex enough for any uneven parts of the tracks of the grid to be absorbed by the SVU without the SVU having to have one wheel in the air.

Further the two wheel modules 701 are connected by a platform 801. This platform 801 is placed over the two wheel modules 701 and separates the top unit and the two wheel modules 701. the intention of the platform 801 is mainly to cover the insides of the two wheel modules 701. the platform 801 is attached to either of the two wheel modules 701 at attachment points 703. At these attachment points the platform 801 is bolted to the frame of the two wheel modules 701. The attachment points 703 has a shock absorbing component 901 that is comprised of one or more attachment point discs 902 and a shock absorbing material. The attachment point disc 902 has a hole in the centre where the bolt connecting the platform 801 to the body of the wheel module 701 is passed through. There can be an additional attachment point disc 902 at the opposing side of the attachment point. The attachment point discs 902 rests against the platform 801 and the frame of the wheel modules 701. Sandwiched between these attachment point discs 902 there is a shock absorbing material. This shock absorbing material can be a rubber material, or it can be a spring. The key feature is that the shock absorbing material is resilient.

The shock absorbing component 901 at each Attachment point 703 ensures that the two wheel modules 701 can flex independently of each other. This ensures that the SVU is capable of absorbing any uneven parts while it is traveling along the tracks on the grid.

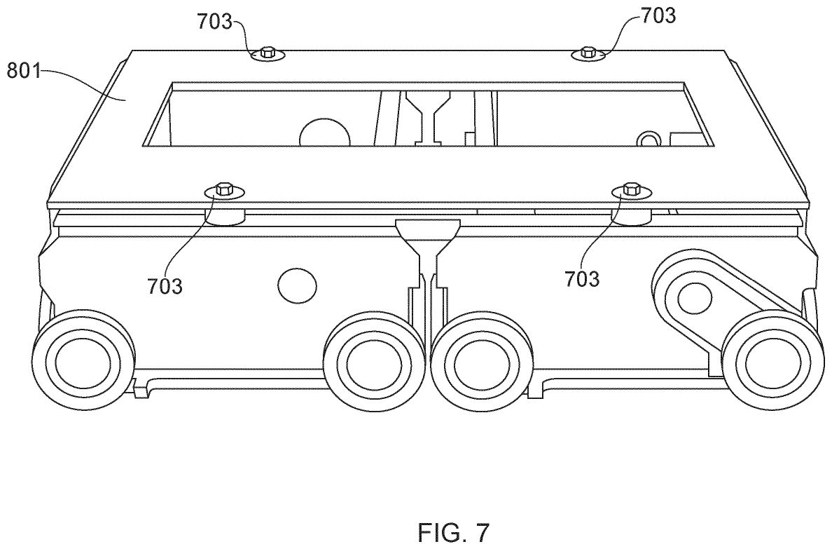

FIG. 7 is a perspective side view of the two wheel modules 701 wherein they are connected to each other by both being connected to the same platform 801. In this embodiment the platform 801 partially covers the top of the two wheel modules 701. The centre of the platform 801 is open. This part of the platform 801 is covered by the top unit of the SVU. The opening in the platform 801 allows the for cables and wires to go from the top unit to the two wheel modules 701. The platform 801 is there to prevent anything from entering into the inner part of the SVU and particularly the wheel modules 701. As is can be seen the platform 801 curves over the edge of the shock absorbing component 901 protecting the inside of the wheel modules 701.

The shock absorbing component 901 allows the two wheel modules 701 to absorb shocks from the tracks when the SVU is traveling over the grid. And since it also allows the wheel modules 701 to move independently a shock to the front of the first wheel module 701 does not affect the second wheel module 701.

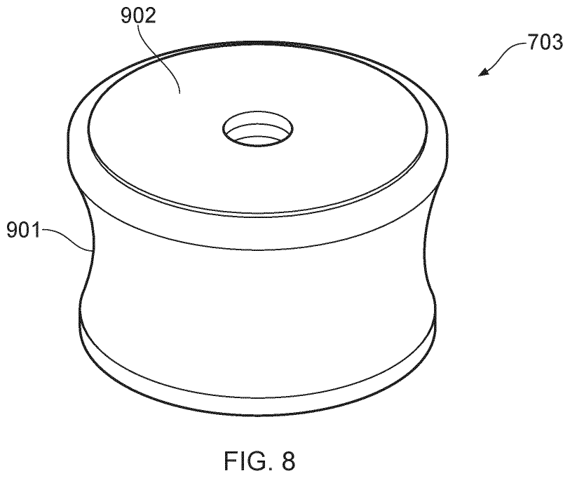

FIG. 8 is a perspective view of a preferred embodiment of a flexible attachment point 703 used for attaching the platform 801 to the wheel modules 701.

The preferred embodiment of the shock absorbing component 901 is comprised of one or more attachment point discs 902 and a shock absorbing material. The attachment point disc 902 has a hole in the centre where the bolt connecting the platform 801 to the body of the wheel module 701 is passed through. There can be an additional attachment point disc 902 at the opposing side of the attachment point 703. The attachment point discs 902 rests against the platform 801 and the frame of the wheel modules 701. Sandwiched between these attachment point discs 902 there is a shock absorbing material. This shock absorbing material can be a rubber material, or it can be a spring. The key feature is that the shock absorbing material is resilient.

The shock absorbing component 901 at each attachment point 703 ensures that the two wheel modules 701 can flex independently of each other. This ensures that the SVU is capable of absorbing any shocks given to the wheel bases as they travel along the tracks on the grid.

### LIST OF REFERENCE NUMBERS

Prior art: FIGS. 1-5, Present invention: FIGS. 6-8:
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art storage container vehicle
201a Vehicle body of the storage container vehicle 101
201b Drive means/wheel arrangement, first direction (X)
201c Drive means/wheel arrangement, second direction (Y)
301 Prior art cantilever storage container vehicle
301a Vehicle body of the storage container vehicle 101
301b Drive means in first direction (X)
301c Drive means in second direction (Y)
304 Lifting platform of the container handling vehicle
401 Prior art storage container vehicle with central cavity solution
401a Vehicle body of the storage container vehicle 401
401b Drive means/wheel arrangement, first direction (X)
401c Drive means/wheel arrangement, second direction (Y)
404 Lifting platform of the container handling vehicle
501 Top unit
X First direction
Y Second direction
Z Third direction
701 Wheel module
702 Torsion bar
703 Attachment point
801 Platform
901 Shock absorbing component
902 Attachment point disc.

1. A service vehicle unit for operating in an automated storage and retrieval grid comprising a first set of rails arranged to guide movement of a container handling vehicle in respective first and second directions relative to the grid, wherein the service vehicle unit comprises:
two or more wheel modules each having two or more wheels for respectively manoeuvring the service vehicle unit in the first and second directions,
wherein the wheels for manoeuvring in the first direction can be lifted and lowered depending on a direction for manoeuvring the wheel module, and
wherein the two or more wheel modules are coupled together using a connecting device.

2. (canceled)

3. The service vehicle unit according to claim 15, wherein the upper plate and the lower plate and the elastic material each have a central hole for receiving a screw or a bolt.

4. The service vehicle unit according to claim 15, wherein the elastic material is a rubber material.

5. The service vehicle unit according to claim 14, wherein the shock absorbing component is a spring.

6. The service vehicle unit according to claim 1, wherein the connecting device is a plexiglass cover.

7. The service vehicle unit according to claim 1, wherein the connecting device comprises at least one metal bar.

8. The service vehicle unit according to claim 1, wherein one wheel module of the two or more coupled wheel modules is configured to act as a master and one or more other wheel modules are configured to act as a slave module.

9. The service vehicle unit according to claim 8, wherein a torsion bar is connected at one end to a track shift mechanism of the master wheel module and at the opposite end connected to a track shift mechanism in the slave wheel module and arranged to ensure simultaneous track shift of the master and the slave wheel module by transferring the power to raise and lower the wheels from the master wheel module to the slave wheel module.

10. The service vehicle unit according to claim 1, wherein the connecting device partially covers the top of the two or more wheel modules.

11. The service vehicle unit according to claim 1, wherein the connecting device fully covers the top of the two or more wheel modules.

12. The service vehicle unit according to claim 1, wherein the shock absorbing component is a helical spring.

13. The service vehicle unit according to claim 1, wherein the connecting device is a platform on which the service vehicle unit body is mounted and attached to the respective frame of the two or more wheel modules at attachment points.

14. The service vehicle unit according to claim 13, wherein there is a shock absorbing component at each attachment point between the connecting device and the frame of the two or more wheel modules.

15. The service vehicle unit according to claim 14, wherein the shock absorbing component is comprised of an upper plate and a lower plate, and an elastic material sandwiched between the upper plate and the lower plate.

16. The service vehicle unit according to claim 3, wherein the elastic material is a rubber material.
